(19) United States
(12) Patent Application Publication
(10) Pub. No.: US 2008/0055216 A1
(43) Pub. Date: Mar. 6, 2008

(54) Liquid crystal display and methods for driving the same

(75) Inventors: Cheng-Chi Yen, Tainan County (TW); Biing-Seng Wu, Tainan County (TW); Yung-Yuan Ho, Tainan County (TW); Ying-Chou Tu, Tainan County (TW)

Correspondence Address: RABIN & Berdo, PC, 1101 14TH STREET, NW, SUITE 500, WASHINGTON, DC, 20005, US

(73) Assignees: Himax Display, Inc., Tainan County (TW); HIMAX TECHNOLOGIES LIMITED, Tainan County (TW)

(21) Appl. No.: 11/812,427

(22) Filed: Jun. 19, 2007

Related U.S. Application Data
(60) Provisional application No. 60/840,706, filed on Aug. 29, 2006.

(51) Int. Cl. G09G 3/36; G09G 5/10

(52) U.S. Cl. 345/87; 345/204; 345/90

(57) ABSTRACT

Embodiments of the present invention set forth methods and systems for driving display devices. In one embodiment, a first set of image data to be displayed on a display panel is stored. During a first time period, a reset signal is asserted to set the display panel associated with a common panel voltage to a predictable state. Subsequent to the first time period, a control signal is asserted to load the first set of image data for a first subframe within a frame on the display panel, wherein this first set of image data is further adjusted by a first adjustable reference voltage. A designated light for the display panel is turned on to display the first set of image data in parallel with the storing of a second set of image data for a subframe within the frame to be displayed.

The current application claims the benefit of U.S. Provisional Application No. 60/840,706, filed on Aug. 29, 2006. This related application is hereby incorporated by reference in its entirety.

### BACKGROUND OF THE INVENTION

1. Field of the Invention

Embodiments of the present invention relate generally to display technologies and more specifically to systems and methods for driving liquid crystal displays.

2. Description of the Related Art

Unless otherwise indicated herein, the approaches described in this section are not prior art to the claims in this application and are not admitted to be prior art by inclusion in this section.

As consumers embrace and demand the high resolution and sleek form factors of their display devices, an impressive array of liquid crystal display (“LCD”) products have been developed. One common type of LCD technology employed in these products is the transmissive LCD technology, which may utilize transistors to drive liquid crystals between glass panels. Another type of LCD technology is the reflective LCD technology, such as the Liquid Crystal on Silicon (“LCOS”) technology, which may utilize transistors to drive liquid crystals on reflective mirror substrate. As the display products continue to increase in size, cost effectively deploying these LCD technologies while still improving the quality of the displayed images remains challenging.

Specifically, in one prior art approach, each pixel cell in a display device utilizes three mirror substrates, each reflecting a red, green, or blue light back to a lighting engine to compute the output color. However, because of the use of three mirror substrates per pixel cell, this approach is likely to be prohibitively costly. In another prior art approach, each pixel cell in the display device is divided into three subpixels, representing a red, green, and a blue light using color filters. Because of the properties of these color filters, the quality of the images generated by this approach tends to suffer, especially in the areas of resolution, saturation, and brightness. In yet another prior art approach, each pixel cell transmits red, green, and blue lights sequentially in time. The lighting cannot be turned on until both the data addressing for all the scan lines in a frame is completed and also the liquid crystals have responded to the voltages. Thus, maintaining a high frame rate as display devices grow in size becomes increasingly difficult, because there often is insufficient time for all the data addressing to complete and the liquid crystals to respond in the current frame prior to the arrival of the next frame. Although some prior art attempts of including frame buffers in pixel cells have been developed to alleviate at least the aforementioned timing issues, none of these attempts is commercially viable, because they fail to adequately consider issues relating to color uniformity and layout optimization for the display devices.

As the foregoing illustrates, what is needed are improved systems and methods for driving LCDs cost effectively and yet still yielding high quality images.

### SUMMARY OF THE INVENTION

Embodiments of the present invention set forth methods and systems for driving display devices. In one embodiment, a first set of image data to be displayed on a display panel is stored. During a first time period, a reset signal is asserted to set the display panel associated with a common panel voltage to a predictable state. Subsequent to the first time period, a control signal is asserted to load the first set of image data for a first subframe within a frame on the display panel, wherein this first set of image data is further adjusted by a first adjustable reference voltage. A designated light for the display panel is turned on to display the first set of image data in parallel with the storing of a second set of image data for a subframe within the frame to be displayed.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a simplified liquid crystal display panel configuration with multiple pixel cells, according to one embodiment of the present invention;

FIG. 1B is an exploded view of a pixel cell, according to one embodiment of the present invention;

FIG. 1C is a simplified diagram of a timing controller and a voltage generator, according to one embodiment of the present invention;

FIG. 1D is a timing diagram illustrating a sequence of preparing and displaying image data on a display panel, according to one embodiment of the present invention;

FIG. 2A is another simplified liquid crystal display panel configuration with multiple pixel cells, wherein the Data Line is either driven with image data or a reset voltage, according to another embodiment of the present invention;

FIG. 2A is another simplified liquid crystal display panel configuration with multiple pixel cells, wherein the Data Line is either driven with image data or a reset voltage, according to another embodiment of the present invention;

FIG. 2B is a timing diagram illustrating a sequence of preparing and displaying image data on the display panel shown in FIG. 2A, according to one embodiment of the present invention;

FIG. 3 is another simplified liquid crystal display panel configuration with multiple pixel cells, wherein an averaged voltage from all the pixel cells is used as a reset voltage, according to another embodiment of the present invention;

FIG. 4A is another simplified liquid crystal display panel configuration with multiple pixel cells, wherein a predictable voltage from a known source is used as a reset voltage, according to another embodiment of the present invention;

FIG. 4B is another simplified liquid crystal display panel configuration with multiple pixel cells, wherein a predictable voltage from a known source is used as a reference voltage, according to another embodiment of the present invention;

FIGS. 5A-5D are simplified liquid crystal display panel configurations with multiple pixel cells illustrating connections for reference voltages and reset voltages, according to another embodiment of the present invention;

FIG. 6A is a timing diagram illustrating the modulation of a reference voltage, the Vref1, according to one embodiment of the present invention;

FIG. 6B is a timing diagram illustrating the modulation of another reference voltage, the Vref2, according to one embodiment of the present invention; and

FIG. 7 is a simplified block diagram of a display device employing the disclosed pixel cell configurations, according to one embodiment of the present invention.

### DETAILED DESCRIPTION

Throughout this disclosure, a “switching device” broadly refers to a device that allows current to flow from one of its terminals to another according to a control voltage. Some examples of this switching device include, without limitation, various types of transistors (e.g., thin film transistors, bipolar junction transistors, and field effect transistors).

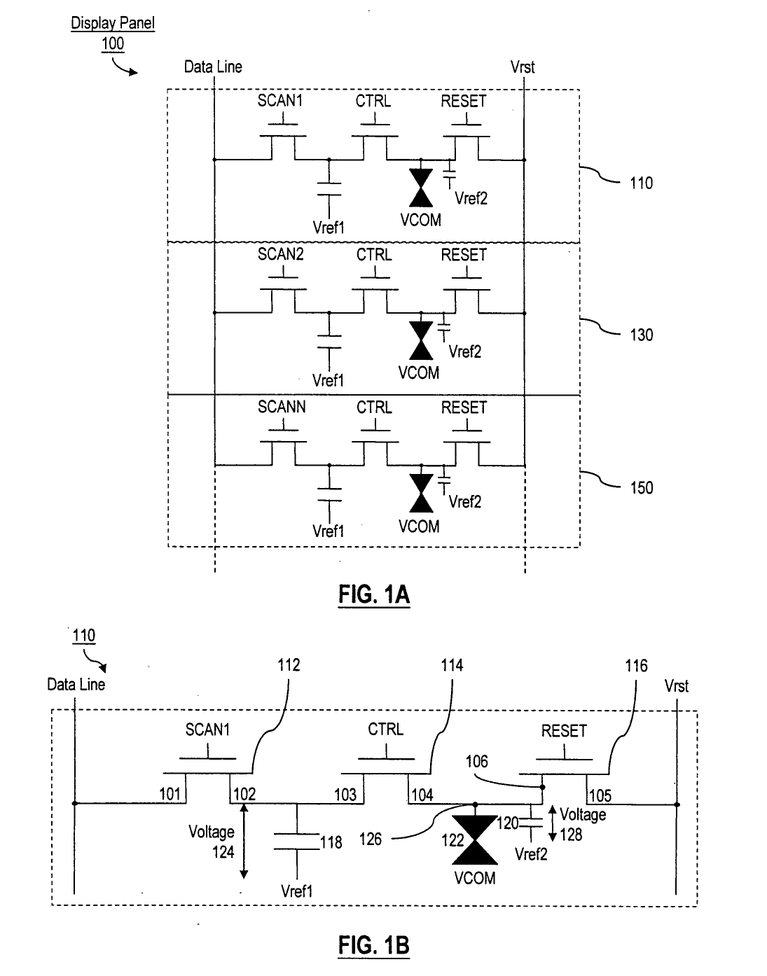

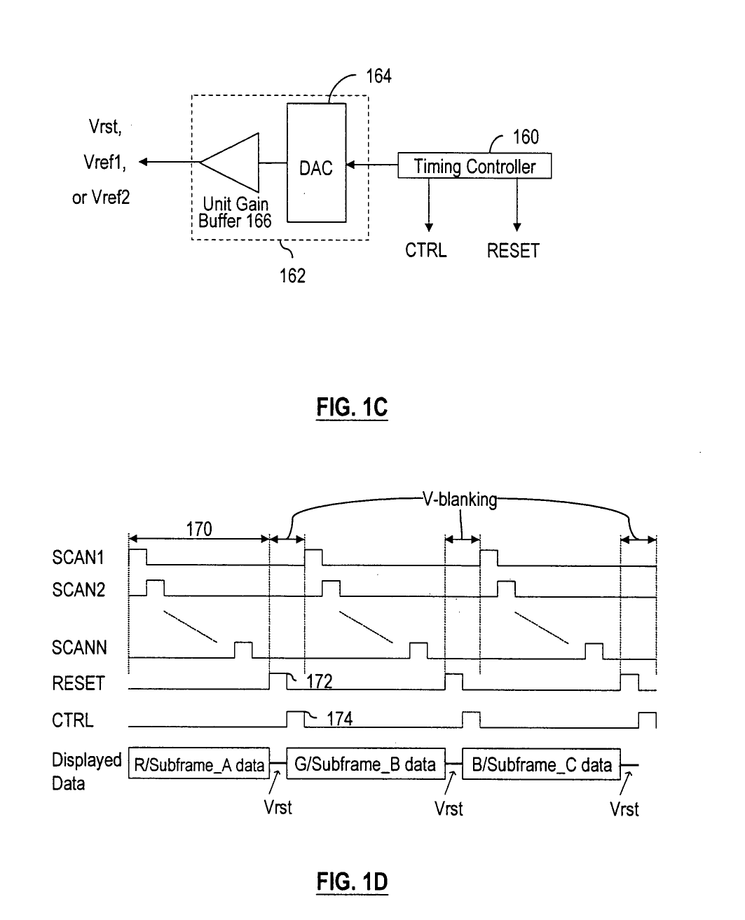

FIG. 1A is a simplified liquid crystal display panel configuration with multiple pixel cells, according to one embodiment of the present invention. Each of the three illustrated pixel cells 110, 130, and 150 of a display panel 100 includes switching devices, storage capacitors, and liquid crystal (LC) materials. By enabling the switching devices at specific times so that the information stored in the storage capacitors are properly applied to the LC materials, the display panel 100 is able to achieve high frame rates while maintaining superior image qualities cost effectively.

More specifically, FIG. 1B is an exploded view of the pixel cell 100, according to one embodiment of the present invention. The pixel cell 110 has switching devices 112, 114, and 116, storage capacitors 118 and 120, and LC material 122. Each of the switching devices has a source terminal and a drain terminal. Here, the switching device 112 has a source terminal 101 and a drain terminal 102; the switching device 114 has a source terminal 103 and a drain terminal 104; and the switching device 116 has a source terminal 105 and a drain terminal 106. The source terminal 101 of the switching device 112 is connected to a column Data Line for the display panel 100, which carries voltages representative of image data. The source terminal 105 of the switching device 116, on the other hand, is connected to a common reset voltage (Vrst) also for the display panel 100. In addition, a first side of the LC material 122 is connected to a common panel voltage (VCOM), while a second side is connected to both the drain terminal 104 and the drain terminal 106. The VCOM is adjustable and is typically established at the beginning of the production phase for the display panel 100.

When the switching device 112 is enabled by an address signal, such as SCAN1, the storage capacitor 118 connected to the drain terminal 102 is energized by the image data that is present on the Data Line. Specifically, the storage capacitor 118 here stores a voltage 124, which corresponds to the image data voltage adjusted by an adjustable reference 1 voltage (Vref1). It should be noted that the Vref1 is common to all the storage capacitors holding the charges associated with the image data in the display panel 100. Additionally, to ensure the color uniformity of the display panel 100, in one implementation, prior to transferring the stored charges associated with the voltage 124 to the LC material 122 for display, the switching device 116 is enabled by a reset signal, such as RESET, so that the Vrst connected to the source terminal 105 is applied to the drain terminal 106. This reset action causes the charging up of the storage capacitor 120, which then helps to put the LC material 122 in a predictable state. Here, the storage capacitor 120 stores a voltage 128, which corresponds to the Vrst adjusted by an adjustable reference 2 voltage (Vref2). It is also worth noting that the Vref2 is common to all the storage capacitors holding the charges associates with the Vrst in the display panel 100. Then, by asserting a control signal, such as CTRL, the switching device 114 is enabled and the stored charges associated with the voltage 124 is transferred to the LC material 122. Subsequent paragraphs will further detail relevant timing information associated with the aforementioned reset-then-display sequence.

FIG. 1C is a simplified diagram of a timing controller 160 and a voltage generator 162, according to one embodiment of the present invention. The timing controller 160 is configured to assert one or more control signals, such as CTRL, and one or more reset signals, such as RESET, and also generate digital values representing the Vrst, Vref1, or Vref2 at certain time intervals. The voltage generator 162 includes a digital-to-analog converter (DAC) 164 and a unit gain buffer 166. The DAC 164 transforms the digital values from the timing controller 160 into analog signals, and the unit gain controller 166 drives the analog signals onto appropriate buses. With the programmability of the timing controller 160, the voltage generator 162 therefore is capable of dynamically adjusting its output signals. In one implementation, the display panel 100 potentially employs three copies of the voltage generator 162, and each copy is responsible for generating one of the Vrst, Vref1, and Vref2. However, it should be apparent to a person with ordinary skills in the art to recognize other approaches of generating the Vrst, Vref1, and Vref2 are available and are within the scope of the claimed invention. Subsequent paragraphs will elaborate on these alternative approaches.

FIG. 1D is a timing diagram illustrating a sequence of preparing and displaying image data on the display panel 100, according to one embodiment of the present invention. A data driver (otherwise referred to as a source driver or an X driver) is typically responsible for driving the image data on the Data Line shown in FIG. 1A. A gate driver (otherwise referred to as a Y driver) is typically responsible for asserting the address signals SCAN1, SCAN2, to SCANN at different times for different rows in the display panel 100. The assertions enable the corresponding switching devices, such as the switching device 112 shown in FIG. 1B, and cause the image data to be effectively loaded on the storage capacitors that are connected to the Vref1, such as the storage capacitor 118. For illustration purposes, suppose asserting the address signals SCAN1, SCAN2, to SCANN during time period 170 causes the loading of all of the G/Subframe_B data in the appropriate storage capacitors in the display panel 100. Then, during the period of no new image data, otherwise referred to as the V-blanking period, the timing controller 160 first asserts RESET 172 and then asserts CTRL 174. Asserting RESET 172 causes all the storage capacitors that are connected to the Vref2 in the display panel 100, such as the storage capacitor 120, to be effectively loaded with the Vrst. By applying the charges corresponding to the Vrst adjusted by the Vref2 to the LC materials in all the pixel cells, the LC materials are placed in a predictable state and are likely to more precisely respond to the already loaded G/Subframe_B data when CTRL 174 is asserted. When the stored G/Subframe_B data are applied to the LC materials, the appropriate lighting is also turned on causing G/Subframe_B data to be displayed on the display panel 100. The same process repeats again by asserting the address signals for the next subframe, B/Subframe_C data in this case, after the V-blanking period. It should be noted that in this illustration, each frame consists of three subframes, each corresponding to a distinct red, green, or blue lighting.

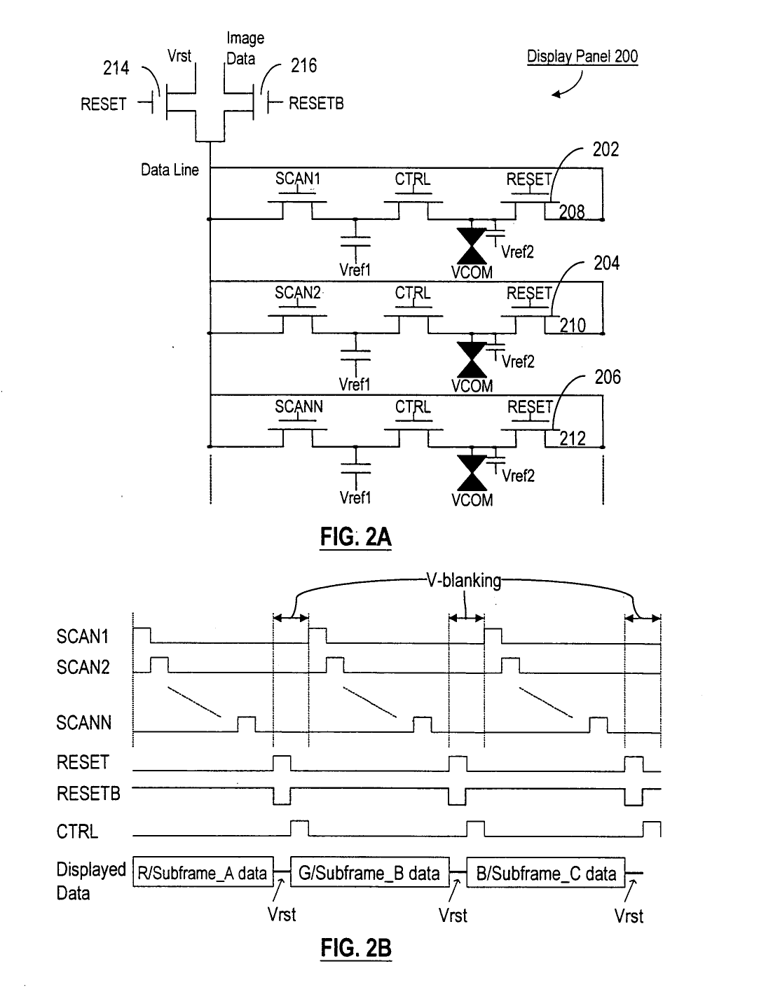

FIG. 2A is another simplified liquid crystal display panel configuration with multiple pixel cells, wherein the Data Line is either driven with image data or a reset voltage, according to another embodiment of the present invention. Unlike the display panel 100 shown in FIG. 1A, the wiring configurations of a display panel 200 are simplified by connecting the source terminals 208, 210, and 212 of switching devices 202, 204, and 206, respectively, to the Data Line. Then, the timing controller 162 shown in FIG. 1C asserts two different rest signals, namely, RESET and RESETB, to drive different sets of data onto the Data Line. In particular, the source terminal of a switching device 214 is connected to the Vrst, and the source terminal of the switching device 216 is connected to image data. So, if the switching device 214 is enabled, then the Vrst is driven onto the Data Line. On the other hand, if the switching device 216 is enabled, then image data is driven on the Data Line. As shown in FIG. 2B, although the timing of asserting SCAN1 to SCANN, RESET, and CTRL and displaying subframes of image data is mostly identical to the timing shown in FIG. 1D, the timing controller 162 in this implementation needs to ensure that RESETB has the opposite polarity of RESET. In other words, when RESET 230 is asserted, RESETB 232 needs to be de-asserted to avoid enabling the switching devices 214 and 216 at the same time.

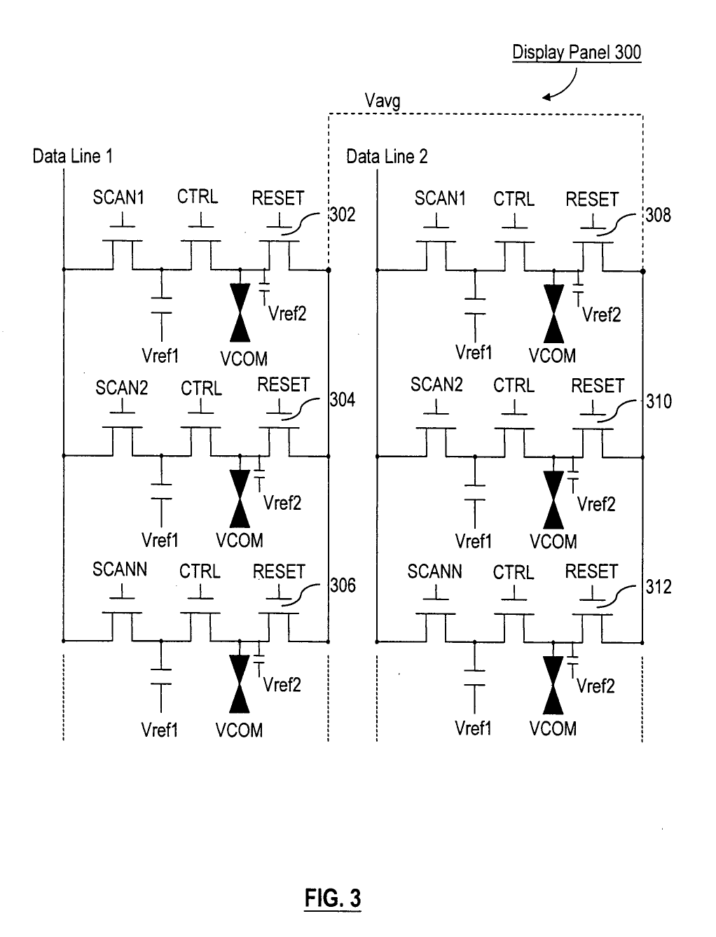

FIG. 3 is another simplified liquid crystal display panel configuration with multiple pixel cells, wherein an averaged voltage from all the pixel cells is used as a reset voltage, according to another embodiment of the present invention. Specifically, the source terminals of all the switching devices to be enabled by RESET, such as switching devices 302, 304, 306, 308, 310, and 312, are all connected together. The timing for driving the various signals to display data on the display panel 300 follows the same timing patterns shown in FIG. 1D. Unlike the Vrst generated by an external source, such as the voltage generator 162 of FIG. 1C, in the display panels 100 and 200, here the Vavg is derived from averaging all the voltages present at these drain terminals after RESET is asserted but before CTRL is asserted. Even though each individual drain terminal may be associated with a different voltage from another drain terminal, averaging all the voltages in the display panel 300 in effect filters out the differences. It should be noted that the Vavg differs from frame to frame as incoming data vary.

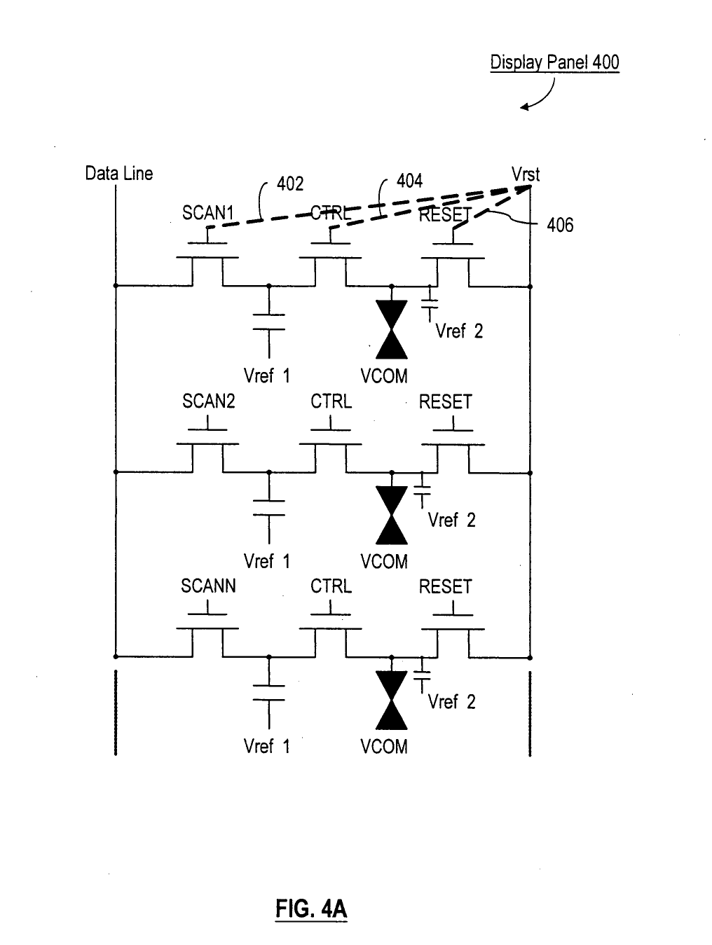

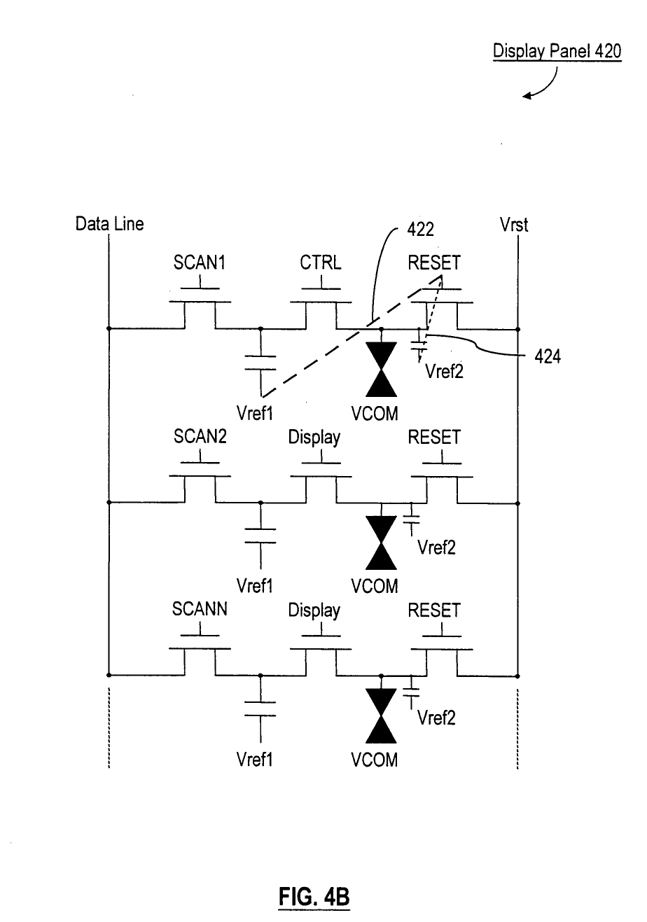

FIG. 4A is another simplified liquid crystal display panel configuration with multiple pixel cells, wherein a predictable voltage from a known source is used as a reset voltage, according to another embodiment of the present invention. Specifically, in one implementation, the Vrst is connected to any of the address signals in a display panel 400, such as SCAN1 via a connection 402. The timing for driving the various signals to display data on the display panel 400 also follows the same timing patterns shown in FIG. 1D. According to FIG. 1D, the voltages of SCAN1 predictably fluctuate between a constant high voltage and a constant low voltage. So, when RESET is asserted, SCAN1 is predictably at the constant low voltage. With the connection 402 and other connections tying the address signals and the Vrst together in the display panel 400, this constant low voltage can then be utilized to place the LC materials in a predictable state after RESET enables the appropriate switching devices. It should be apparent to a person with ordinary skills in the art to recognize that the Vrst can also be connected other predictable voltages, such as CTRL or RESET via a connection 404 or a connection 406, respectively. With the connection 404, a constant low voltage is utilized to place the LC materials in a predictable state, because CTRL is low when RESET is asserted. However, with the connection 406, a constant high voltage instead is utilized to place the LC materials in a predictable state.

FIG. 4B is another simplified liquid crystal display panel configuration with multiple pixel cells, wherein a predictable voltage from a known source is used as a reference voltage, according to another embodiment of the present invention. Specifically, in one implementation, the Vref1 or the Vref2 is connected to RESET in a display panel 420 via a connection 422 or a connection 424, respectively. The timing for driving the various signals to display data on the display panel 420 still follows the same timing patterns shown in FIG. 1D. According to FIG. 1D, when an address signal, such as SCAN1, is asserted, RESET is predictably at a constant low voltage according to FIG. 1D. This constant low voltage is then used as the Vref1 for the storage capacitors containing the image data from the Data Line in the display panel 420. As for the Vref2, when the Vref2 is also connected to RESET, the storage capacitors using the Vref2 as the reference voltage in the display panel 420 contain charges corresponding to the difference between Vrst and RESET, which still help to place the LC materials in a predictable state.

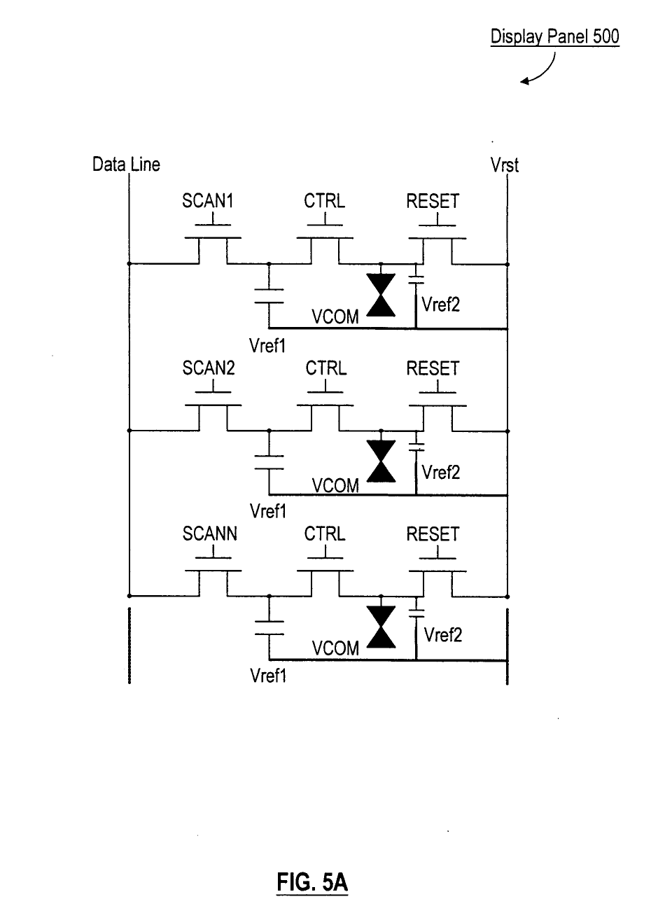

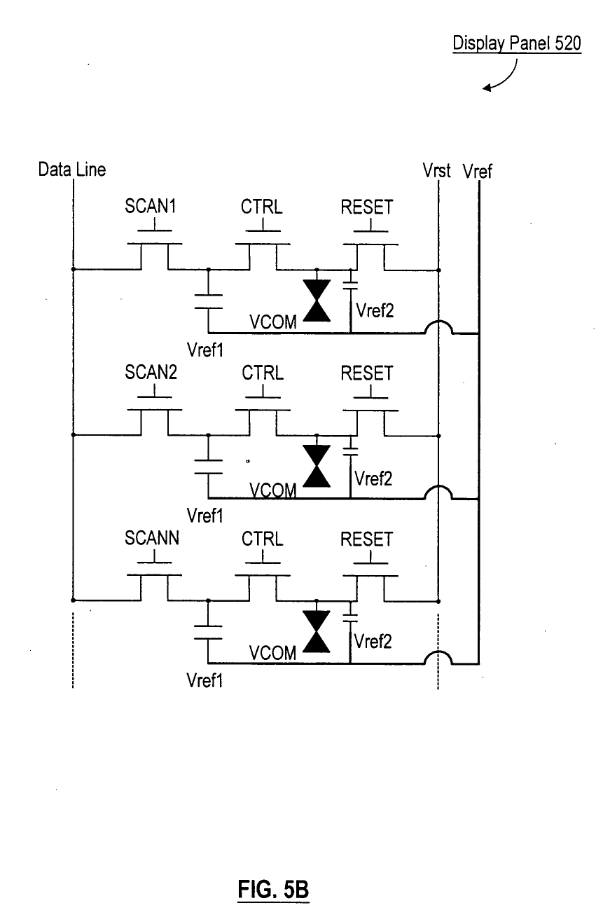

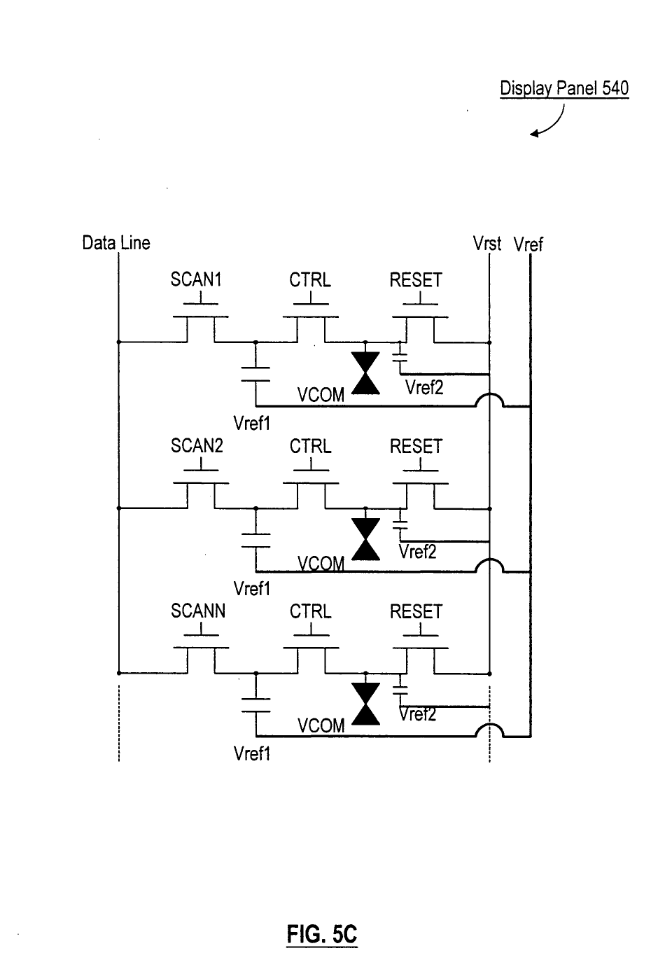

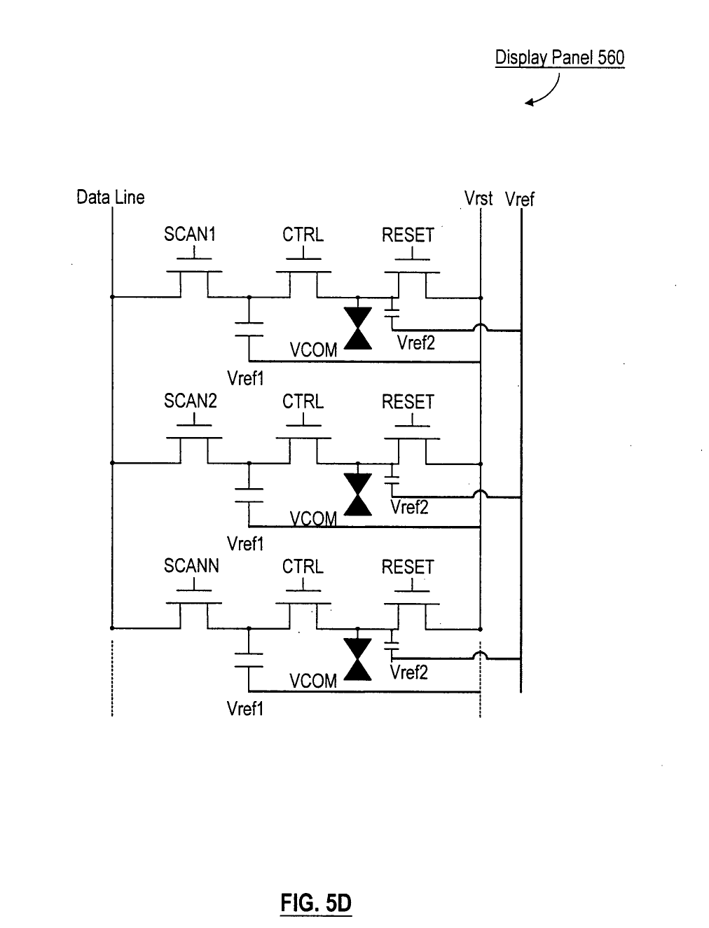

FIG. 5A is another simplified liquid crystal display panel configuration with multiple pixel cells, wherein reference voltages and reset voltages are connected together, according to another embodiment of the present invention. Specifically, in one implementation, the reference voltages, such as the Vref1 and Vref2, are connected to the Vrst in a display panel 500. This approach simplifies wirings and still provides a predictable and potentially adjustable voltage, the Vrst, for the Vref1 and Vref2. Alternatively, as shown in FIG. 5B, another predictable and potentially adjustable voltage, a Vref, is connected to the Vref1 and Vref2 in a display panel 520. The Vref can be generated by the voltage generator 162 shown in FIG. 1C or other external sources. In yet another alternative implementation shown in FIG. 5C, the Vref1 is connected to the Vref, and the Vref2 is connected to the Vrst in a display panel 540. In still another implementation shown in FIG. 5D, the Vref1 is connected to the Vrst, and the Vref2 is connected to the Vref in a display panel 560.

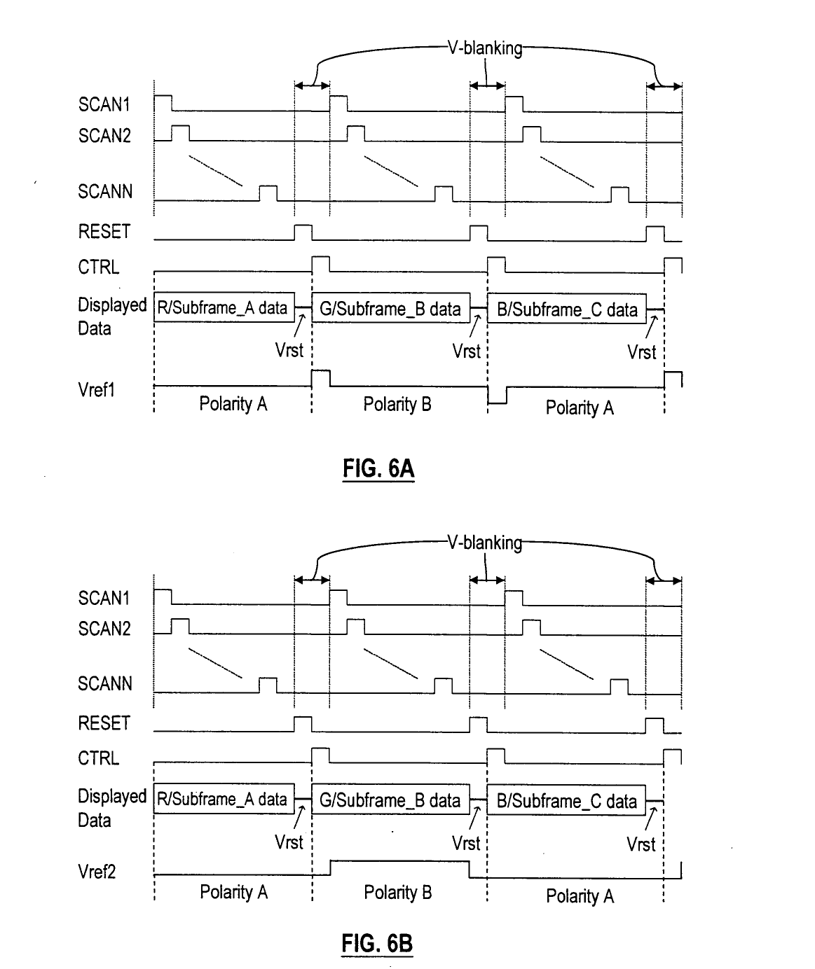

To reduce the effect of voltage drops from connecting the various reference voltages together, one implementation is to modulate the reference voltages. FIG. 6A is a timing diagram illustrating the modulation of the Vref1, according to one embodiment of the present invention. In conjunction with FIG. 1B, suppose the voltage at the source terminal 103 is Vi. While CTRL is asserted, the charges stored in the storage capacitor 118 are shared with the storage capacitor 120. As a result, the voltage at the drain terminal 104 equals to the voltage at the source terminal 103. The magnitude of this voltage is smaller than the magnitude of the original Vi due to the sharing of charges. By modulating Vref1, Vref1 is pulled high to V+ΔV in a positive polarity cycle (i.e., polarity B shown in FIG. 6A) while CTRL is asserted. This way, any voltage drop due to the sharing of charges may be reduced. Similarly, Vref1 is pulled low to V-ΔV in a negative polarity cycle while CTRL is asserted, so that that the voltage drop due to the sharing of charges may be reduced.

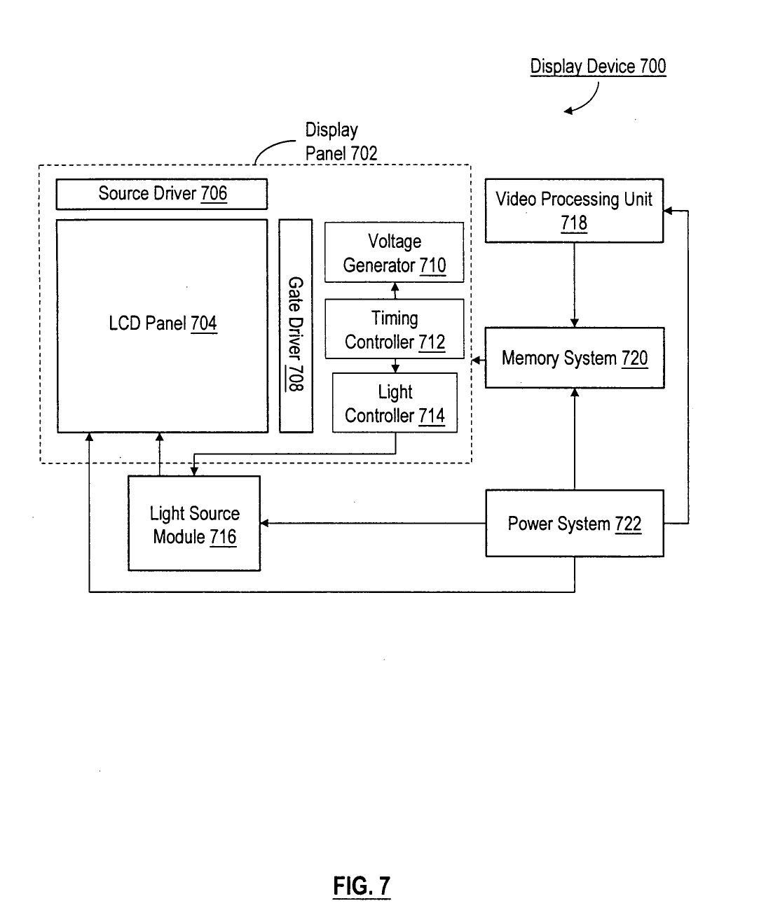

FIG. 7 is a simplified block diagram of a display device 700 employing the aforementioned pixel cell configurations, according to one embodiment of the present invention. The display device 700 includes a display panel 702, a light source module 716, a video processing unit 718, a memory system 720, and a power system 722. The display panel 702 further includes a LCD panel 704, a source driver 706, a gate driver 708, a voltage generator 710, a timing controller 712, and a light controller 714. The LCD panel 704 can be a transmissive type, a reflective type, or a transflective type panel. In addition, one implementation of the LCD panel 704 is on silicon. Such a construction is broadly referred to as the Liquid Crystal on Silicon (LCOS) technology. In another implementation, the LCD panel 704 is on glass, such as a Thin Film Transistor (TFT) LCD.

As discussed above, the source driver 706 is typically responsible for driving image data on column data lines of the LCD panel 704, and the gate driver 708 is typically responsible for asserting address signals at different times for different rows in the display panel 702. The source driver 706 receives data from the memory system 720 via the timing controller 712, and the gate driver 708 receives control information also from the timing controller 712. In addition to asserting reset signals and control signals and generating reference and/or reset voltages as discussed above, the timing controller 712 also provides timing information for the light controller 714 to drive the light source module 716. The light source module 716 provides the appropriate lighting to the LCD panel 704 to display the image data. The light source module 716 can utilize a number of technologies alone or in combination, such as, without limitation, light-emitting diode (LED), organic light-emitting diode (OLED), color wheel, and cold cathode fluorescent lamp (CCFL). The video processing unit 718 can be one or more dedicated processing engines to operate on incoming video data. The processed video data are stored or even further processed in the memory system 720 (e.g., the memory system 720 may include the frame rate conversion functionality) before being scanned out to the display panel 702. In addition to the processed video data, the memory system 720 may also provide timing and control information for the display panel 702. Lastly, the power system 722 supplies power to the components of the display device 700, such as the LCD panel 704, the light source module 716, the video processing unit 718, and the memory system 720.

The above description illustrates various embodiments of the present invention along with examples of how aspects of the present invention may be implemented. The above examples, embodiments, and drawings should not be deemed to be the only embodiments, and are presented to illustrate the flexibility and advantages of the present invention as defined by the following claims. Based on the above disclosure and the following claims, other arrangements, embodiments, implementations, and equivalents will be evident to those skilled in the art and may be employed without departing from the spirit and scope of the invention as defined by the claims.

What is claimed is:

1. A method for driving a display panel in a display device, comprising:
asserting a reset signal to set the display panel associated with a common panel voltage to a predictable state during a first time period;
after asserting the reset signal, asserting a control signal to load a first set of image data for a first subframe within a frame on the display panel, wherein the first set of image data is further adjusted by a first adjustable reference voltage; and
turning on a designated light for the display panel to display the first set of image data in parallel with storing a second set of image data for a second subframe within the frame to be displayed.

2. The method of claim 1, wherein the frame includes three subframes.

3. The method of claim 2, wherein the turning on step further comprises assigning one of three colors to the designated light.

4. The method of claim 2, wherein the first time period refers to a period between asserting the reset signal and asserting a second address signal to start storing the second set of image data.

5. The method of claim 4, wherein the step of asserting the reset signal and the step of asserting the control signal both occur during the first time period.

6. The method of claim 1, further comprising storing the first set of image data in a first storage capacitor associated with the first adjustable reference voltage prior to the asserting of the control signal.

7. The method of claim 6, further comprising applying a first predictable voltage to a liquid crystal material after asserting the reset signal.

8. The method of claim 7, further comprising adjusting the first predictable voltage by a second adjustable reference voltage.

9. The method of claim 7, further comprising generating the first predictable voltage by a voltage generator.

10. The method of claim 9, further comprising driving the first predictable voltage onto a data line at a different time than driving image data onto the data line.

11. The method of claim 7, further comprising deriving the first predictable voltage from connecting together the source terminals of a plurality of switching devices enabled by the reset signal in the display panel.

12. The method of claim 7, further comprising deriving the first predictable voltage from an address signal for enabling the storing of image data in the first storage capacitor.

13. The method of claim 7, further comprising deriving the first predictable voltage from the control signal.

14. The method of claim 7, further comprising deriving the first predictable voltage from the reset signal.

15. The method of claim 6, further comprising deriving the first adjustable reference voltage from the reset signal.

16. The method of claim 8, further comprising connecting a first terminal of the first storage capacitor associated with the first adjustable reference voltage and a second terminal of a second storage capacitor associated with the second adjustable reference voltage together to a second predictable voltage.

17. The method of claim 8, further comprising connecting a first terminal of the first storage capacitor associated with the first adjustable reference voltage to a second predictable voltage and connecting a second terminal of a second storage capacitor associated with the second adjustable reference voltage to a third predictable voltage.

18. The method of claim 8, further comprising modulating the first adjustable reference voltage based on a polarity.

19. The method of claim 18, further comprising modulating the second adjustable reference voltage based on the polarity.

20. A pixel cell in a display panel, comprising:
a first storage capacitor associated with a first adjustable reference voltage;
a reset switching device controlled by a reset signal to set a liquid crystal material associated with a common panel voltage in the pixel cell to a predictable state during a first time period;
a control switching device controlled by a control signal to apply a first set of image data for a first subframe within a frame from the first storage capacitor to the liquid crystal material after asserting the reset signal; and
a light source module to turn on a designated light for the display panel to display the first set of image data in parallel with the first storage capacitor storing a second set of image data for a second subframe within the frame to be displayed.

21. The pixel cell of claim 20, wherein the frame includes three subframes.

22. The pixel cell of claim 21, wherein the light source module assigns one of three colors to the designated light.

23. The pixel cell of claim 21, wherein the first time period refers to a period between asserting the reset signal and asserting a second address signal to start storing the second set of image data.

24. The pixel cell of claim 23, wherein the reset signal and the control signal are respectively asserted during the first time period.

25. The pixel cell of claim 20, wherein the first set of image data is stored in the first storage capacitor prior to the control signal being asserted.

26. The pixel cell of claim 25, wherein the reset switching device applies a first predictable voltage to the liquid crystal material after being enabled by the reset signal.

27. The pixel cell of claim 26, further comprising a second storage capacitor for storing charges associated with the first predictable voltage adjusted by a second reference voltage.

28. The pixel cell of claim 26, wherein a voltage generator generates the first predictable voltage.

29. The pixel cell of claim 28, wherein a multiplexing arrangement ensures driving the first predictable voltage onto a data line at a different time than driving image data onto the data line.

30. The pixel cell of claim 26, wherein the source terminal of the reset switching device is connected to the source terminals of other reset switching devices in other pixel cells in the display panel that are also enabled by the reset signal to determine the first predictable voltage.

31. The pixel cell of claim 26, wherein the source terminal of the reset switching device is connected to an address signal to determine the first predictable voltage.

32. The pixel cell of claim 26, wherein the source terminal of the reset switching device is connected to the control signal to determine the first predictable voltage.

33. The pixel cell of claim 26, wherein the source terminal of the reset switching device is connected to the reset signal to determine the first predictable voltage.

34. The pixel cell of claim 25, wherein the terminal of the first storage capacitor with the first adjustable reference voltage is connected to the reset signal.

35. The pixel cell of claim 27, wherein the terminal of the first storage capacitor with the first adjustable reference voltage and the terminal of the second storage capacitor with the second adjustable reference voltage are connected together to a second predictable voltage.

36. The pixel cell of claim 27, wherein the terminal of the first storage capacitor with the first adjustable reference voltage is connected to a second predictable voltage and the terminal of the second storage capacitor with the second adjustable reference voltage is connected to a third predictable voltage.

37. The pixel cell of claim 27, wherein the first adjustable reference voltage modulates based on a polarity.

38. The pixel cell of claim 37, wherein the second adjustable reference voltage modulates based on the polarity.

39. A display device, comprising:
a video processing unit;
a memory system;
a power system; and
a display panel, wherein the display panel includes a plurality of pixel cells, each of which further includes:
a first storage capacitor associated with a first adjustable reference voltage,
a reset switching device to set a liquid crystal material associated with a common panel voltage in the pixel cell to a predictable state during a first time period, if a reset signal is asserted to enable the reset switching device, and
a control switching device to apply a first set of image data from the first storage capacitor for a first subframe within a frame to the liquid crystal material subsequent to the first time period, if a control signal is asserted to enable the control switching device; and
a light source module to turn on a designated light for the display panel to display the first set of image data in parallel with the first storage capacitor storing a second set of image data for a second subframe within the frame to be displayed.
